(19) United States
(12) Patent Application Publication
(10) Pub. No.: US 2016/0186464 A1
(43) Pub. Date: Jun. 30, 2016

(54) ELECTROSTATIC LOCK

(71) Applicant: Evgeniy Anatolevich OBZHIRVO, Moscow (RU)

(72) Inventor: Evgeniy Anatolevich OBZHIROV, Moscow (RU)

(21) Appl. No.: 14/910,296

(22) PCT Filed: Aug. 4, 2014
(86) PCT No.: PCT/RU2014/000577

§ 371 Date: Feb. 5, 2016

(30) Foreign Application Priority Data
Aug. 7, 2013 (RU) 2013136762

(51) Int. Cl. E05B 47/00

(52) U.S. Cl. CPC E05B 47/0001; E05B 2047/0057

(57) ABSTRACT

The electrostatic lock (ESL) relates to devices for fixing separate parts or elements of various mechanisms and devices and for keeping same in a fixed state relative to one another, with the possibility of subsequent converse disengagement thereof, and functions on the basis of an electrostatic (coulomb) attractive force between electrodes which are charged with opposite electrical charges and are separated by a sufficiently narrow layer of a dielectric. The ESL is supplemented with a special blocking mechanism consisting of two main mechanically separable parts, one of which is a blockable part, and the other is a reciprocal part thereto. Furthermore, the ESL electrodes are arranged compactly on the reciprocal blocking part with the aid of a kinematic connection, which makes it possible to completely isolate the electrodes from a contaminant and from other harmful effects of the environment, which may make it impossible for the ESL to work.

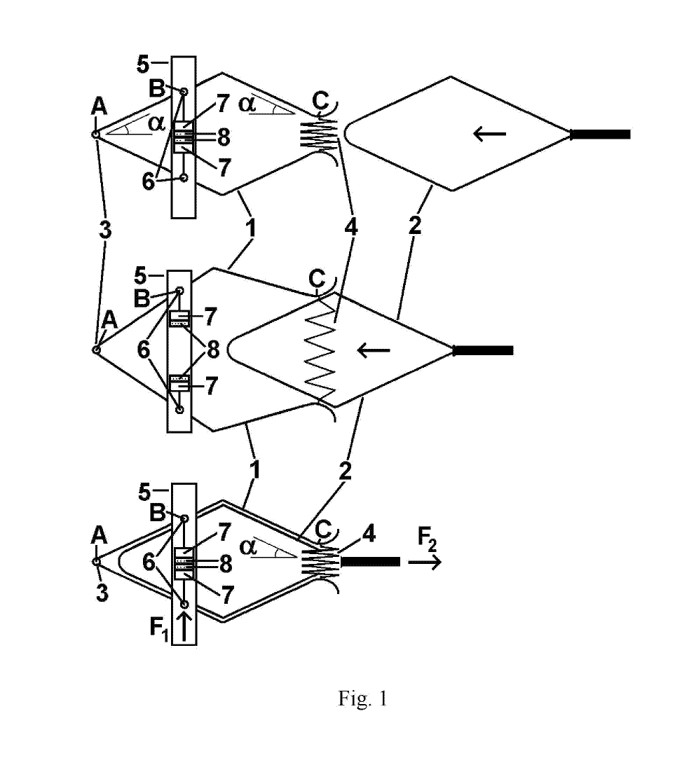

### TECHNICAL FIELD AND INDUSTRIAL APPLICABILITY

Electrostatic lock (ESL) relates to devices for fixing and keeping individual parts or elements of various mechanisms and devices in a fixed state relative to each other, and operates by electrostatic (Coulomb) attraction force between the electrodes, charged with opposite electric charges and separated by a layer of dielectric. This device can serve as a locking device (lock), and also can be used for many other similar technical purposes.

### RELATED ART

It is known such an electrostatic lock (RF patent application 2012152879/20(084266), utility model RF patent 129134) being a device for fixing and keeping individual parts or elements of various mechanisms and devices in a fixed state relative to each other by electrostatic (Coulomb) attraction force comprising fixable electrodes mechanically or kinematically coupled to the parts or elements to be fixed to each other, wherein the electrodes may be connected to an electric power supply to be charged with opposite electric charges, and comprising at least a dielectric layer separating the oppositely charged electrodes in such a way that the oppositely charged electrodes, when the ESL is fixed (locked), are tightly fixed together through the dielectric they are separated with, and further comprising electric valves for connecting the ESL to an electric power supply thus providing a guaranteed stable build-up of electrical charges on the electrodes.

A main drawback of such an ESL when operated is a sensibility to pollution of the electrode effective surfaces in their mutual contact areas when the ESL is locked. For instance, a feeble amount of common dust makes it impossible to lock an ESL or at most weakens the attraction force between the electrodes by many times through unrecoverable microscopic air gaps occurring between the electrodes being fixed. As known, dust particles may be of different size: up to 0.1 μm—particles, i. e. <<steam>>; from 0.1 to 10 μm—<<cloud>> or <<mist>>; over 10 μm—properly dust. Of a particular danger there are small dust particles of less than 5 μm, staying suspended in the air for long, especially in the case of high air movement. Moreover any dust, dirt and atmospheric moisture condensate on the electrode effective surfaces altogether with said phenomenon of the microscopic air gaps occurring in the electrode contact area reduce the ESL operational efficiency by times or make it impossible due to the presence of electrostatic induction: upon the ESL locking polarization charges occur on the contact surfaces between the dust or condensate particles and the electrodes, said charges being opposite to the charges of the electrodes, wherein the electrostatic field of said polarization charges completely shields the charges of the electrodes from interaction and mutual attraction. Therefore the effective contact surfaces of the ESL electrodes ought to be absolutely clean all along the operation term which could be achieved at least by their being insulated from the atmospheric environment.

Another problem of still grave concern for operation of such a device is a necessity of a most accurate adjustment of the ESL counterparts to each other when being assembled on a mechanical appliance to be locked with the ESL. The required accuracy may reach an order of less than a micron, while the operating distances between the ESL electrodes applied in the unlocked state may reach a meter and even more. Such an adjustment may prove too expensive or hard to attain. Moreover, due to micro-deformations constantly arising during the operation, the need for such an adjustment may occur many times in the future, which is extremely undesirable or may prove infeasible.

Actually, getting rid of said drawbacks in the ESL operation is the foremost object of the invention and the desired technical effect to be achieved.

### SUMMERY OF THE INVENTION

The problem is solved as follows: besides the electrodes being fixed relative to each other and the dielectric they are separated with, in such a way that the oppositely charged electrodes, when the ESL is fixed (locked), are tightly fixed together through the dielectric they are separated with, the ESL further comprising a blocking mechanism the parts of which are kinematically connected to device to be fixed with the ESL; said blocking mechanism is comprised of two parts—a blockable part and its slidable counterpart, comprising at least two slidable flaps, herewith the ESL being unlocked the blockable part can be easily (with but slight pressure applied) made come in and out of the counterpart as well, and when being locked the blockable part is engaged inside the counterpart; wherein the ESL electrodes are kinematically connected to the corresponding slidable flaps thus allowing for three main operation states as follows: (1st) the blockable part is outside the counterpart, the counterpart is locked, the ESL electrodes are tightly fixed together through the dielectric they are separated with; (2nd) the blockable part is partially inside the counterpart meanwhile being partially or completely apart, the ESL electrodes are separated with an extra gap; (3rd) the blockable part is completely inside the counterpart, the flaps of which are moved close together, and the ESL electrodes are tightly fixed together through the dielectric they are separated with, and the ESL electrodes being oppositely charged causes Coulomb attraction force to appear between the electrodes, thus preventing the counterpart flaps from sliding apart, and the blockable part is rigidly fixed inside the counterpart while the ESL turns into the locked state.

### PREFERRED EMBODIMENT OF THE INVENTION

For clarity, the ESL as above is shown in FIG. in said three main states: in the top of FIG.—just prior to the ESL locking (1st state); in the middle of FIG.—about the middle phase of locking, when the ESL counterpart (1) housing is expanded by turning around a hinge (3) under mechanical action of the ESL blockable part (2) in the course of its translatory motion from right to left and the part (2) enters the counterpart (1), wherein the ESL electrodes (7) kinematically coupled to the counterpart flaps with hinges (6) slide apart along guides (5), and an air gap appears therebetween (2nd state); in the bottom of FIG.—the ESL being locked, when the ESL blockable part (2) is completely inside the counterpart (1) and a retraction spring mechanism (4) tightly presses the ESL electrodes (7) together, with a dielectric layers (8) therebetween, and the electrodes are connected to an electric charge supply (not shown), resulting in an electrostatic attraction force blocking the part (2) relative to the counterpart (1) (3rd state).

Thus, in the described device all the possible movements of the electrodes are compactly limited with the electrode guides (5), which allows for placing the electrodes into a sealed enclosure (container), which, for example, may match the element (5).

The device as described is somewhat alike with electromechanical door latches (EDL), widely used at present. Within an EDL the lock blocking occurs due to an electromagnet, driving a special mechanism which turns the lock into a blocked state (for initially unlocked EDL) or into an unblocked state (for initially locked EDL). Though there exists a considerable difference between EDL and ESL of fig. consisting in that, upon an EDL locking the naturally-occurring movement of the door mechanism and parts of the lock is accompanied with an inner blocking element shift into a blocked state, and further keeping the EDL locked and excluding non-sanctioned unlocking is achieved due to the inner mechanical elastic forces acting between the lock parts, while an ESL blocking takes place affected by the electrostatic attraction forces between the electrodes only. This causes yet another fundamental difference: for instance while opening an EDL-door being in a blocked state, if an outer force exceeding a critical value (modules of rupture) is applied and thus the EDL is unlocked, the device will break down turning inoperable; and an ESL in this case will unlock without any damage. Meanwhile the only risk for an ESL is a high voltage on the electrodes, that is generated across the electrodes during the opening and may exceed the breakdown voltage; in order to avoid this, it suffices to provide the ESL electrodes with a shunt device which will lock the ESL electrodes when the voltage between the electrodes exceeds a reference value that is lower than the breakdown voltage value.

### Technical Effects Achieved

Thus, the present invention allows for achieving the following technical effects:
it allows for significant reduction or complete elimination of contaminated contact area of the ESL electrodes when operating, for even a feeble amount of such contaminants not only reduces the ESL efficiency but also may cause the ESL operation failure;
it eliminates the need for high-precision and expensive adjustment of the EPS elements when assembling, the equipment for providing, multiple precise contacts and a tight junction between the electrodes of the ESL when locked in the course of operation;
it enables simplification and reduction in price of the equipment mounting, because such a construction involves wiring performed only for one of the mechanical parts of the device to be locked: for example, for the counterpart of the lock on the door frame, whereas common ESL in this case involves electrical equipment mounting and wiring for the door leaf either.

Note that the mechanical force needed to open the ESL will be determined by the value of the electric charges accumulated on the electrodes, the value of which in its turn is determined by the voltage between the electrodes in the initially locked state, which provides wide extra opportunities of using the ESL for industrial purposes, as it allows for controlling the force of the ESL unlocking This property is peculiar to all the ESL. Yet the present invention allows for a further opportunity of using a mechanical lever effect for increasing the effective force of keeping the device locked that is another technical effect, achieved by the present invention. If for common ESL the electrostatic attraction force F₁, at least sufficient for keeping the ESL locked, is equal to an outer mechanical force F₂, applied for unlocking the ESL, then for the shown ESL (the bottom of FIG.), F₁ also will depend on the angle a as well as on the location of the points A, B and C relative to each other shown in FIG. (the distances between AB and AC) according to the following formula, easily drawn from the equality of moments relative to the point A between the force F₁ and the elastic retraction force of the blockable part, exercised by the latter upon the counterpart flap (normally to the flap and being equal to F₂ sin(α)): F₁=F₂sin(a)|AC|/|AB|. If the electrodes (7), the guides (5) and the kinematic couplings (6) are combined with the retraction mechanism (4) (the point B coinciding the point C), such a correlation is obtained: F₁=F₂sin(α)cos(α). Also other variants are possible when |AB| exceeds |AC|. In general this correlation should make provision not only for the device geometry but for the material properties as well (elastic and friction coefficients).

### BRIEF DESCRIPTION OF THE DRAWINGS

For better clarity of the above material the invention is illustrated by a drawing of FIG. represented in three main states: in the top of FIG.—just prior to the ESL locking (1st state); in the middle of FIG.—about the middle phase of locking, when the ESL blockable part is half-way inside its blocking counterpart (2nd state); in the bottom of FIG.—the ESL being locked, when the ESL blockable part is completely inside the counterpart.

According to FIG. ESL Comprises:

1—an ESL housing counterpart, comprising two symmetrical portions;

2—an ESL blockable part, mechanically coupled to the kept fixed part of the mechanism to be locked with an ESL;

3—a hinged joint of the ESL housing counterpart (1) symmetrical portions;

4—a retraction spring assembly;

5—vertical guides for the ESL electrodes;

6—a kinematic coupling between the ESL electrodes and the ESL counterpart (1);

7—oppositely chargeable ESL electrodes;

8—a dielectric layer separating the electrodes (7).

1. Electrostatic lock (ESL) as a device for fixing and keeping individual parts or elements of mechanical appliances in a fixed state relative to each other with electrostatic (Coulomb) attraction force, comprising electrodes fixable relative to each other and connectible to an electric power supply for making the electrodes oppositely charged and comprising at least a layer of dielectric separating the oppositely charged electrodes from each other in such a way that the oppositely charged electrodes, when the ESL is fixed (locked), are tightly fixed together through the dielectric they are separated with, characterised in further comprising a locking mechanism, the parts of which are kinematically connected to the device to be locked with the ESL; said locking mechanism is comprised of two parts—a lockable part and its slidable counterpart, comprising at least two slidable flaps, herewith the ESL being unlocked the lockable part can be easily, or with but slight pressure applied, made come in and out of the counterpart as well, and when being locked the lockable part is engaged inside the counterpart; wherein the ESL electrodes are kinematically connected to the corresponding slidable flaps thus allowing for three states as follows: (1st) the blockable part is outside the counterpart, the counterpart is locked, the ESL electrodes are tightly fixed together through the dielectric they are separated with; (2nd) the blockable part is partially inside the counterpart meanwhile being partially or completely apart, the ESL electrodes are separated with an extra gap; (3rd) the blockable part is completely inside the counterpart, the flaps of which are moved close together, and the ESL electrodes are tightly fixed together through the dielectric they are separated with, and the ESL electrodes being oppositely charged causes Coulomb attraction force to appear between the electrodes, thus preventing the counterpart flaps from sliding apart, and the blockable part is rigidly fixed inside the counterpart while the ESL turns into the locked state.

2. Electrostatic lock (ESL) of claim 1, characterised in further comprising a special retraction mechanism, generating an extra force to apply pressure to the counterpart flaps, the force being low enough in order not to impede the counterpart flaps sliding apart when the blockable part comes in and out of the counterpart under normal operation conditions, yet high enough to provide the counterpart flaps with a guaranteed retraction into the locked state, when the blockable part is completely inside the ESL counterpart or completely outside it.

3. Electrostatic lock (ESL) of claim 1, characterised in further comprising a sealed enclosure, completely isolating the ESL electrodes from contaminants and other harmful effects of the environment, yet enabling the ESL electrodes to slide apart inside the enclosure together with sliding the ESL counterpart flaps and to return into a tight contact upon locking the ESL.

4. Electrostatic lock (ESL) of claim 3, characterised in comprising special gas or gas mixture inside the enclosure for preventing moisture condensation or other phase transformations of the gas mixture inside the ESL under normal operation conditions.

5. Electrostatic lock (ESL) of claim 3, characterised in further comprising a mechanical-to-electrical energy converter, partially converting the mechanical force energy making, the blockable part move inside the counterpart during the ESL locking into electrical energy for providing the ESL electrodes with electrical charges required for its locking.

6. Electrostatic lock (ESL) of claim 5, characterised in that the mechanical-to-electrical converter is combined with the counterpart retraction mechanism.
